(19) United States
(12) Patent Application Publication
(10) Pub. No.: US 2019/0105721 A1
(43) Pub. Date: Apr. 11, 2019

(54) Rapidly detachable horizontal work table for a combination horizontal-vertical band saw

(71) Applicant: Jeffrey A. Hedrick, Portland, OR (US)

(72) Inventor: Jeffrey A. Hedrick, Portland, OR (US)

(21) Appl. No.: 16/132,414

(22) Filed: Sep. 15, 2018

Related U.S. Application Data
(60) Provisional application No. 62/536,363, filed on Jul. 24, 2017.

(51) Int. Cl. B23D 55/02; B23D 53/00

(52) U.S. Cl. CPC B23D 55/023; B23D 53/006

(57) ABSTRACT

A rapidly detachable table for a host combination vertical-horizontal band saw that provides an enlarged work platform in the vertical cutting mode. The table employs a rapidly activated latching mechanism so that the table is quickly installed to operate in the enhanced vertical cutting mode and quickly removed to allow normal horizontal cutting operation. The portfolio of cuts that the saw can make is increased, as is the accuracy of the cuts in the vertical cutting mode.

### CROSS-REFERENCE TO RELATED APPLICATIONS

Not applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present patent is an improvement to a type of band saw with a horizontally running blade pivoting from above and behind the clamped work material, cutting into or through clamped material as the blade descends, that also converts to a vertically running blade whereby the blade running path is stationary and the operator feeds the material through the blade. This type of saw is a combination tool because it has modes to cut in both the horizontal and the vertical axis.

The combination band saw design includes a small plate that is identified as a “deflector plate” and/or an optional fixable work supporting table. The term “deflector” or “deflector plate” describes the function of the plate during horizontal operation when the plate serves to protect the saw blade alignment mechanism, and the blade itself, by deflecting material that is cut away or that fails to stay clamped, since this material will most likely be ejected toward the trailing blade alignment mechanism, which is protected by being covered by the deflector plate. This deflector plate is small by design because of clearance issues when the arm of the saw containing the blade descends during horizontal cuts. In the vertical cutting mode, this deflector operates as a very small work surface in lieu of attaching the optional larger work table with fasteners and tools.

The table area of the deflector plate is very small and does not provide a stable platform for the work material in the vertical cutting mode. As such, the saw is optimized for the horizontal mode and lacks a stable platform in the vertical mode when the optional work table is not installed. The saw will not function in the horizontal cutting mode when the optional work table is installed due to interference as the blade descends.

The advantage of the rapidly detachable band saw table is to improve, in the vertical cutting mode, the stability of the work material via a larger work surface, improving the quality of the cut and increasing the repertoire of cuts possible, while at the same time increasing the safety of the saw by providing an increased impediment between the blade and the operator's hands. The rapidly removable table augments and overcomes the deficiencies of the standard deflector plate in the vertical cutting mode and since the attachment plate remains attached in the embodiments in the same location as the prior art deflector, the operation of the horizontal mode is not affected.

Each embodiment incorporates a latch or catch device to support rapid attachment and detachment of the table. In each embodiment, the saw can change modes very rapidly, specifically without additional or separate fasteners or requiring the use of tools.

The operator finds more stability, resulting in safer and more accurate cuts in the vertical cutting mode due to a larger work surface than the deflector. It was only discovered during prototype testing, that the operator uses the band saw much more frequently when the saw is switched between horizontal cutting and vertical cutting modes efficiently, without giving up the larger work surface in the vertical cutting mode. This is because the full repertoire of cuts supported by a large work surface are accessed without a time consuming table attachment process that may send the operator to an alternate cutting tool. Being able to install or remove a large work table in a few seconds instead of a few minutes proved to increase productivity significantly.

In addition to providing a larger work surface area that the operator uses to keep his hands farther from the blade above and underneath the table, an embodiment of the table includes an enhanced guard that covers the blade beneath the table to protect the operator in a wider and sturdier fashion.

In some embodiments, the front of the table is tailored with an accessory attachment system to support an accessory, such as an extension to the table or cutting alignment tools such as a guide for cutting round stock or rectangular stock at an angle, both longitudinally.

In the embodiment of a longer table or extension accessory embodiment, a table with more area extending toward the operator is constructed with a support appendage that swings down from the table to be clamped in the host saw's native horizontal clamping vice. The extension of the table and addition of the front leg that clamps in the horizontal vice strengthens the overall structure. This makes the work surface more durable and allows larger and heavier materials to be handled in the vertical mode, increasing the utility of the saw. This embodiment also does not require the use of tools or separate fasteners to attach to or detach from the saw.

### BRIEF SUMMARY OF THE INVENTION

A detachable horizontal work table for a combination horizontal-vertical band saw, that is attached and detached rapidly from a fixed attachment plate on the saw, substantially increasing the support area of the work surface and reducing blade to hand exposure in the vertical cutting mode without adding a significant conversion period. The fixed attachment plate is attached in the same position as the original deflector plate preserving the functionality of the horizontal cutting mode. A latching mechanism is incorporated that does not require additional or separate fasteners and does not require the use of tools. The latching mechanism provides a precise, solid attachment that is facilitated in an expedient fashion.

### BRIEF DESCRIPTION OF THE SEVERAL VIEWS OF THE DRAWING

FIG. 1 is a perspective overview of one embodiment of the present invention mounted on the prior art representative host horizontal-vertical band saw.

FIG. 2 is a detail enlargement defined in FIG. 1, showing one embodiment of the present invention installed in relation to the blade and this embodiment includes a blade guard.

FIG. 3 is a perspective overview of one embodiment of the present invention with an attached accessory table extension with support leg, mounted on the prior art representative host horizontal-vertical band saw.

FIG. 4 is a perspective view of the bottom side to display the front accessory attachment system.

FIG. 5 is a bottom view of the table 24 showing pockets for the adapter plate 34 and adapter plate rear adjustable retainers 36 in an embodiment using a cam lock pocket captured plate type of latch.

FIG. 6 is a cross section defined by FIG. 5.

FIG. 7 is a perspective side explosion view of the present invention of an embodiment using a cam lock pocket captured plate type of latch.

FIG. 8 is an enlarged perspective view of the front top side of the adapter plate 34, with hidden lines expressed as dashed lines.

FIG. 9 is an enlarged perspective view of the front top side of the adapter plate adjustable retainer pair 36 used in this embodiment, with hidden lines expressed as dashed lines.

FIG. 10 is an enlarged perspective view of the front top side of the Cam lock cam 31 used in this embodiment.

### DETAILED DESCRIPTION OF THE SEVERAL VIEWS OF THE DRAWING

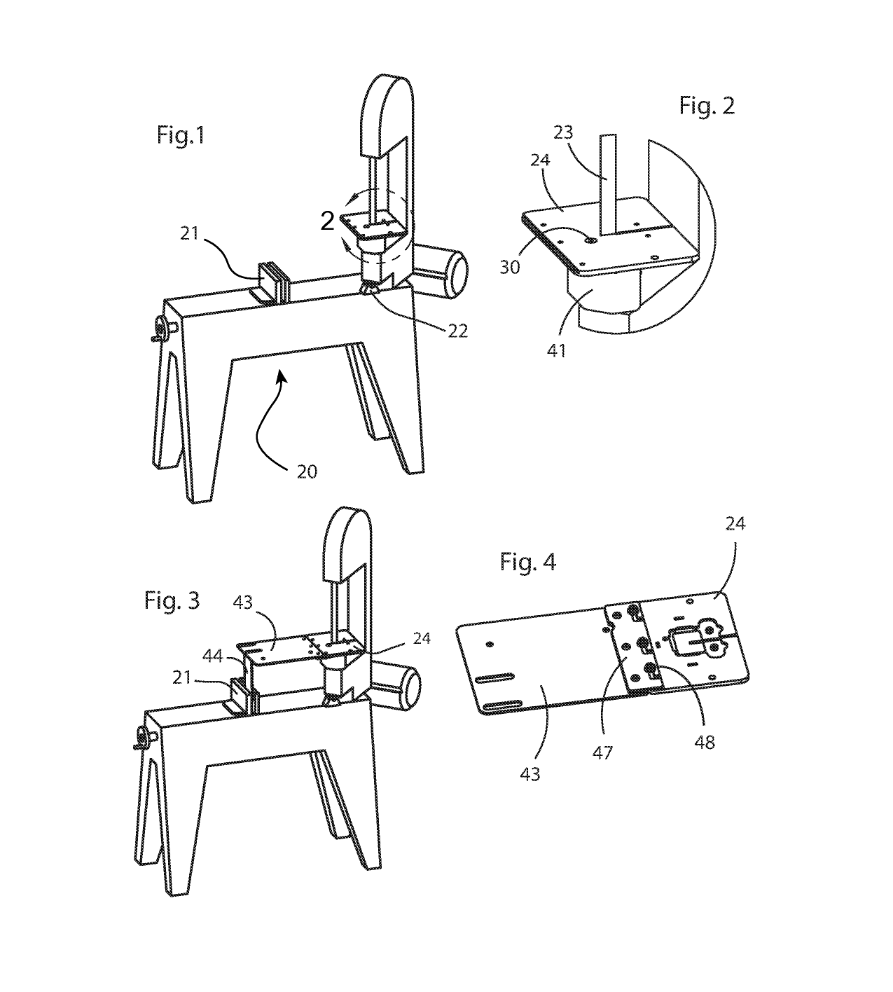

FIG. 1

20 is the Horizontal-Vertical Band Saw host representative for the present invention. 21 is the vice jaws of the host saw. 22 is the horizontal to vertical mode articulation pivot point of the host saw. 2 identifies the detail section containing the present invention that is presented in FIG. 2.

FIG. 2

23 is the saw blade of the host saw. 24 is the present invention table. 30 is the cam lock pivot screw in this embodiment. 41 is the blade guard in this embodiment.

FIG. 3

43 is an example of a table extension using a front accessory attachment system in one embodiment. 44 is a support leg for table extension 43 that clamps in the host saw vice 21.

FIG. 4

24 is the table. 43 is the extended accessory table. 47 is the accessory attachment lock plate. 48 are the fasteners used to secure the accessory attachment lock plate 47. 44 Accessory table extension leg components have been omitted for clarity. 48 accessory attachment lock plate fasteners consist of studs screwed into accessory fastener threaded holes 40 and nuts.

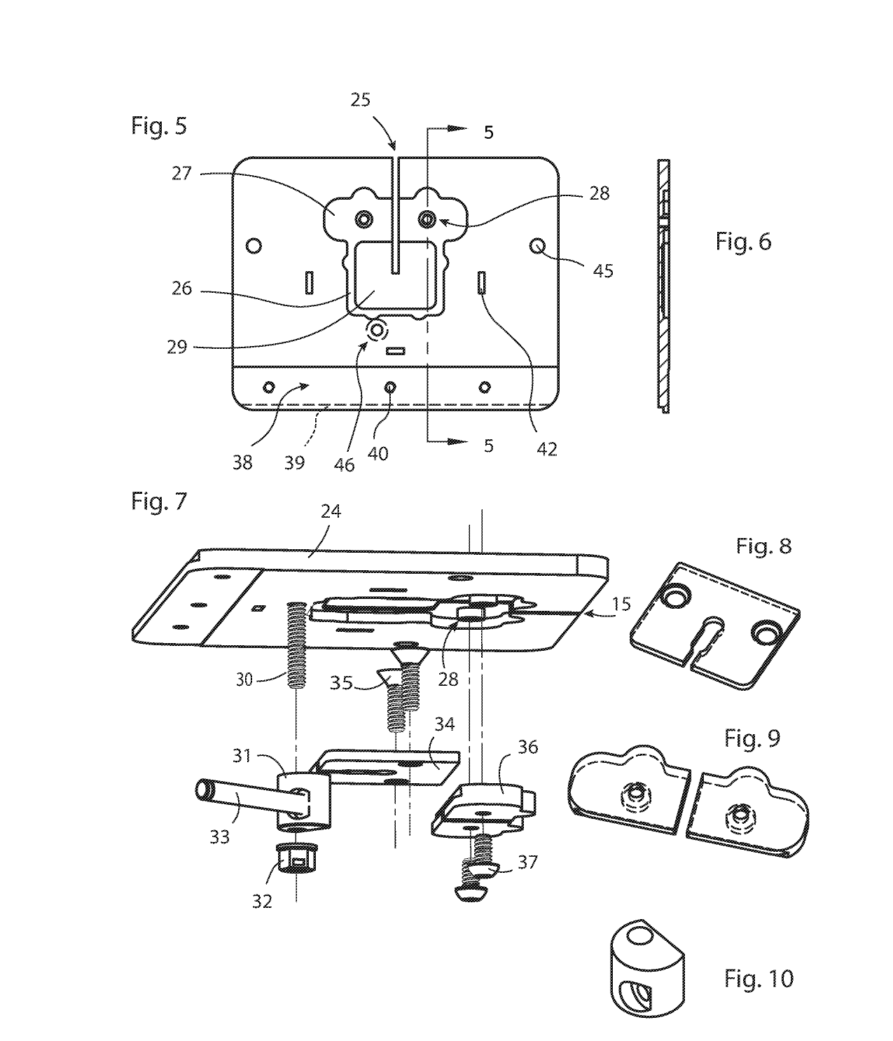

FIG. 5

25 is a blade slot to allow installation of the invention around the blade 23. It is denoted for clarity as a slot that the blade runs in and this slot can have a clearance tolerance or be designed as a zero tolerance blade slot in different embodiments. 25 is contained in a separate plate component of the table in another embodiment. 27 is a pocket that provides a nesting position for the adapter plate rear adjustable retainers 36. 26 is a pocket that provides a nesting position for the adapter plate 34. 29 is a chip pocket to provide additional clearance for debris. 28 are pedestals that assist in locating and adjusting the adapter plate rear adjustable retainers 36. 38 and 39 are dados that are part of the front accessory attachment system in this embodiment. 46 indicates the position of the cam lock pivot hole location in this embodiment. 40 indicates threaded screw holes for the accessory mounting system in this embodiment. 42 are pockets for locating the blade guard 41 in this embodiment. 45 are through holes to be used to allow the invention to be stored on a hook.

FIG. 6.

There are no individually identified signs in the cross section view. The cross section pockets are identified by lines and shading.

FIG. 7

24 is the table. 25 is the blade slot. 30 is the cam lock pivot screw. 31 is the cam lock cam. 32 is the cam lock pivot nut. 33 is the cam lock lever arm. 35 are the adapter plate attachment screws. 34 is the adapter plate. 28 are the adapter plate retainer alignment pedestals. 36 are the adapter plate adjustable rear retainers. 27 are the rear adjustable adapter plate retainers 36 mounting and adjustment screws. The blade guard 41 that would be shown in this embodiment has been removed for clarity but can be seen in FIGS. 1, 2 and 3.

### DETAILED DESCRIPTION OF THE INVENTION

This is an improvement to a combination horizontal-vertical band saw or an accessory for such a saw. This detachable table does not affect the horizontal operation of the saw.

The basic configuration of the present invention is the configuration without any accessories that increase the length of the work table surface.

The present invention can be made of various materials and utilizing various manufacturing methods. As long as the components are sufficiently rigid, they can be produced from any combination of billet stock or castings and subtractive machining as well as additive methods such as 3D printing, and can be made of metals or polymers or other materials as long as the process results in sufficiently rigid and sufficiently accurate components. In particular, the table surface must have adequate structural integrity so that additional supports are not necessary in the basic configuration. In addition, the structural integrity of the table will support a table accessory attachment system used in some embodiments. The individual pieces of each embodiment can be assembled with fasteners and/or bonding and fusing processes.

A latch, or catch or other latching mechanism of the table that supports the rapid detachment and attachment operations is employed in each embodiment. The embodiment depicted in the figures uses a pivotally mounted lever cam lock mechanism to lock the adapter plate into the adapter plate pocket, but other embodiment may use a button latch, a sliding latch, a magnetic catch, spring loaded mechanisms, or any other type of mechanism that supports a sufficiently rigid and rapid operation, including self-latching mechanisms. The essential attributes are rigidity, rapid operation, no additional fasteners, and tool-less attachment/detachment.

To operate the invention, the operator places the band saw in the vertical cutting position. The prior art deflector plate or optional fixed work table that came with the host saw is permanently replaced with the adapter plate 34, a shape similar to the deflector plate that is specifically sized for consistent compatibility and constructed of a thicker and stronger material. The adapter plate need never be removed, as the deflector does, because it is an integral part of the rapidly removable table of the invention. In an embodiment using a pocket in the table to capture and hold the adapter plate with a set of rear retainers and a cam lock in the front, the cam lock lever arm 33 is placed in the unlatched position, if it is not already. The mating surfaces are checked to be clear of significant obstructing debris and brushed off if necessary. The table is slid onto the adapter plate 34, with the blade in the blade slot 25, at a lifted angle so the front of the table 24 is slightly higher than the rear of the table 24. As the retainers 36 passes the rear of the adapter plate 34, the table pocket 26 will fall over the adapter plate 34 in the rear. The table 24 is then pulled forward and downward until the front of the adapter plate 34 seats into the adapter plate pocket 36. The cam lock lever arm 33 is moved to the latched position.

In the event that additional accessories are used on the invention, additional operations may be necessary. For example, if the table extension 43 shown in FIG. 3 is employed and not already attached, it will also be necessary to attach the accessory to table 24 using the accessory attachment system and to make sure that the extension support leg 44 is placed between the host saw vice jaws 21. The vice is then tightened. In the accessory attachment system displayed in FIG. 4, the accessory is attached by sliding the accessory onto the dado cuts of the table 24 with the mounting studs of the accessory attachment lock plate fasteners 48 inline with longitudinal slots in the accessory attachment lock plate 47 and then sideways so that the accessory is positioned inline with the table 24. The three accessory attachment lock plate fastener 48 nuts are then tightened.

To remove the invention for horizontal mode operations, reverse the attachment instructions above.

Using the present invention to make cuts, once installed, is per normal vertical band saw usage.

### CONCLUSIONS, RAMIFICATIONS, AND SCOPE

The rapidly detachable band saw table improves, in the vertical cutting mode, the stability of the work material via a larger work surface, improving the quality of the cut and allowing more types of cuts to be made while at the same time increasing the safety of the saw by providing an increased impediment between the blade and the operator's hands. The expedient installation of the invention with an enhanced vertical cutting mode results in a wider range of usage for the saw, allowing it to handle jobs and cuts that are not possible or are unsafe without the invention. The expedient removal of the invention prevents any deterrent from using the horizontal cutting mode.

All embodiments preserve the rapid attachment and removal characteristic of the improvement and utilize a variety of latching mechanisms.

Some embodiments also include improved blade guarding components.

Some embodiments lengthen the table toward the operator and add a reinforcement leg that clamps into the host saw horizontal work vice.

Some embodiments utilize an accessory attachment system to attach an extension or cutting alignment tools.

### REFERENCE SIGNS

20. Horizontal-Vertical Band Saw host for the present invention.
21. Horizontal-Vertical Band Saw vice jaws.
22. Horizontal-Vertical Band Saw horizontal to vertical mode articulation pivot point.
23. Blade
24. Table.
25. Blade 23 slot.
26. Adapter plate 34 pocket.
27. Rear adjustable retainers 26 pocket.
28. Adapter plate retainer 26 retainer alignment pedestals.
29. Chip pocket.
30. Cam lock pivot screw.
31. Cam lock cam.
32. Cam lock pivot nut.
33. Cam lock 31 lever arm.
34. Adapter plate.
35. Adapter plate 34 mounting screws.
36. Adapter plate 34 rear adjustable retainers.
37. Adapter plate retainer 36 mounting and adjustment screws.
38. Accessory joint dado bottom.
39. Accessory joint dado top.
40. Accessory fastener threaded holes.
41. Blade guard.
42. Blade guard 41 mounting pockets.
43. Accessory table extension.
44. Accessory table extension 43 support leg.
45. Storage hanger holes.
46. Cam lock pivot hole location
47. Accessory attachment lock plate
48. Accessory attachment lock plate fasteners

I claim:

1. A detachable horizontal work table for a combination horizontal-vertical band saw, comprising:
a. a fixed attachment plate, and
b. a horizontal work surface, and
c. a means for latching that supports attachment and detachment of said horizontal work table to said fixed attachment plate,
whereby when attached to the fixed attachment plate in the vertical cutting mode, said horizontal work table substantially increases the area of the work surface, increases the repertoire of cuts the saw can handle, increases the accuracy of the cuts, and reduces blade to hand exposure in comparison to the saw configured for use in the horizontal cutting mode.

2. The fixed attachment plate of claim 1, wherein said fixed attachment plate is attached in the same position as the original deflector plate so as to avoid impacting the horizontal cutting mode of the saw.

3. The means for latching of claim 1, wherein said means for latching is used to attach or detach said horizontal work table without additional or separate fasteners.

4. The means for latching of claim 1, wherein said means for latching is used to attach or detach said horizontal work table without requiring the use of tools.

5. The means for latching of claim 1, wherein said means for latching is used to attach or detach said horizontal work table without additional truss elements or other reinforcement pieces in the basic configuration.

6. The means for latching of claim 1, wherein said means for latching rapidly attaches said horizontal work table to change the saw from horizontal cutting mode to vertical cutting mode.

7. The means for latching of claim 1, wherein said means for latching rapidly detaches said horizontal work table to change the saw from vertical cutting mode to horizontal cutting mode.

8. The means for latching of claim 1, wherein said means for latching attaches or detaches said horizontal work table in an expedient fashion, rarely requiring more than five seconds.
